(19) United States
(12) Patent Application Publication
(10) Pub. No.: US 2019/0337096 A1
(43) Pub. Date: Nov. 7, 2019

(54) METHOD FOR IMPROVING ENGRAVING QUALITY OF LASER ENGRAVING MACHINE

(71) Applicant: GREAT COMPUTER CORP., New Taipei City (TW)

(72) Inventors: Tsung-I CHEN, New Taipei City (TW); Jing-Shian LIN, New Taipei City (TW)

(21) Appl. No.: 15/968,246

(22) Filed: May 1, 2018

(51) Int. Cl. B23K 26/362; B23K 26/08; B44B 3/00

(52) U.S. Cl. CPC B23K 26/362; B44B 3/009; B23K 26/0876

(57) ABSTRACT

A method for improving engraving quality of a laser engraving machine is provided. At least one type of engraving parameter for a workpiece under processing is configured or stored in a database of a computer terminal. After an apparatus terminal receives one of the engraving parameters in the database, an engraving device on the apparatus terminal is driven to perform an engraving operation. When the engraving device moves back and forth on the same engraving path, the engraving device performs the engraving operation in only one direction.

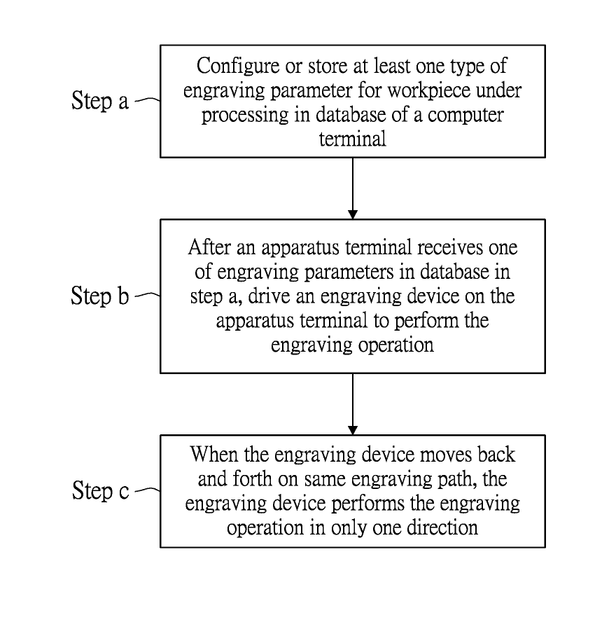

### BACKGROUND OF THE INVENTION

### Field of the Invention

The present invention relates to a low-cost method capable of effectively enhancing product quality and precision for improving engraving quality of a laser engraving machine.

### Description of the Related Art

The process of laser engraving is quite simple, as using a computer and printer to perform printing on paper. Given that various patterns have been edited, the patterns can be “printed” to an engraving machine through a computer. One difference between the two is that, common printing applies ink onto paper, whereas laser engraving primarily guides a beam outputted by laser to a surface of an object to be engraved, such as a wood product, acrylic, a plastic plate, a metal plate or a stone material. The focused beam is absorbed by the material, the temperature is instantly increased, and gasification is accordingly produced, such that the surface of the object is recessed to achieve the object of engraving.

The grid density of laser processing in current laser engraving is extremely high. Thus, output quality of the process of engraving is very susceptible to influence from an engraving machine, resulting in quality and precision issues of processed products. Manufactures have attempted to enhance the quality of engraved products by means of defocusing, reducing the precision of engraved patterns, increasing the output energy of laser, or even manufacturing higher precision engraving assemblies and components, in a way that the engraving process complexities or labor hours are inevitably increased, thus correspondingly significantly increasing production cost.

### SUMMARY OF THE INVENTION

Therefore, it is an object of the Applicant to enhance product quality and precision through a process without increasing too much cost.

It is primary object of the present invention to provide a low-cost method capable of enhancing product quality and precision for improving engraving quality of a laser engraving machine.

To achieve the above object, the present invention provides a method for improving engraving quality of a laser engraving machine. In the method, at least one type of engraving parameter for a workpiece under processing is configured or stored in a database of a computer terminal. When an apparatus terminal receives one of the engraving parameters in the database, an engraving device on the apparatus terminal is driven to perform an engraving operation. Further, when the engraving device moves back and forth on the same engraving path, the engraving device performs the engraving operation in only one direction.

In implementation, the engraving device performs the engraving operation on the workpiece under processing during an outbound movement, and halts the engraving operation during the inbound movement.

In implementation, the engraving device is driven and rotated by a motor.

The invention will become better understood with regard to the following detailed description of the preferred but non-limiting embodiments. The following description is made with reference to the accompanying drawings and denotations to describe specific content and expected results of the present invention.

### BRIEF DESCRIPTION OF THE DRAWINGS

The Sole FIGURE is a flowchart of an embodiment of the present invention.

### DETAILED DESCRIPTION OF THE INVENTION

The Sole FIGURE shows a method for improving engraving quality according to a preferred embodiment of the present invention.

Referring to The Sole FIGURE, the method for improving engraving quality of the present invention is primarily applied to a laser engraving operation, and a process thereof includes following steps.

In step a, at least one type of engraving parameter for a workpiece under processing is configured or stored in a database of a computer terminal.

In step b, after an apparatus terminal receives one of the engraving parameters in the database in step a, an engraving device on the apparatus terminal is driven to perform an engraving operation.

In step c, when the engraving device moves back and forth on an engraving path, the engraving device performs the engraving operation in only one direction.

In implementation, when the workpiece under processing is placed at the apparatus terminal and engraving operation is to be performed, the engraving device may be driven by a motor according to the engraving parameter provided by the computer terminal, and prepares to start engraving. A movement mode of the engraving device on the apparatus terminal is configured as, an outbound movement (forward movement) and an inbound movement (backward movement) of a next path are performed only after the engraving device has completed an outbound movement (forward movement) and an inbound movement (backward movement) of the current path. Thus, in step b of the present invention, when the engraving device moves back and forth on the same engraving path, the engraving device is caused to perform the engraving operation in only one direction. For example, on the same path, laser engraving is performed during only the outbound movement (forward movement), and laser engraving is halted during the inbound movement (backward movement).

Thus, with the above design, when the engraving device moves back and forth on the same engraving path, the engraving device performs the engraving operation in only one direction, thereby effectively alleviating the issue of degraded quality caused by laser processing when a motor operates in different directions, further enhancing the engraving precision and quality.

An embodiment of the present invention and technical means applied are as described above. Based on the disclosure or teaching of the description, numerous variations and modifications may be derived, which are to be considered as equivalent changes of the concept of the present invention. Hence, the effectiveness generated by such variations and modifications are within the substantial spirits covered by the description and drawings, and are to be encompassed within the technical scope of the present invention.

In conclusion, based on the above disclosure, the method for improving laser quality of a laser engraving machine of the present invention is capable of achieving expected objects of the present invention, and provides industrial applicability. Therefore, a patent application is submitted accordingly.

It should be understood that different modifications and variations could be made from the disclosures of the present invention by the people familiar in the art, which should be deemed without departing the spirit of the present invention.

What is claimed is:

1. A method for improving engraving quality of a laser engraving machine, comprising steps of:
step a: configuring or storing at least one type of engraving parameter for a workpiece under processing in a database of a computer terminal;
step b: after an apparatus terminal receives one of the data parameters in the database in step a, driving an engraving device on the apparatus terminal to perform an engraving operation; and
step c: the engraving device, when moving back and forth on a same engraving path, performing the engraving operation in only one direction.

2. The method for improving engraving quality of a laser engraving machine according to claim 1, wherein in step c, the engraving device performs the engraving operation on the workpiece under processing during an outbound movement, and halts the engraving operation on the workpiece under processing during an inbound movement.

3. The method for improving engraving quality of a laser engraving machine according to claim 1, wherein the engraving device is driven and rotated by a motor.
